(19) United States
(12) Patent Application Publication
(10) Pub. No.: US 2004/0129413 A1
(43) Pub. Date: Jul. 8, 2004

(54) Environmental air treatment system

(76) Inventor: Robert W. Yoho SR., Clearwater, FL (US)

Correspondence Address: Edward P. Dutkiewicz, P.O. Box 511, Largo, FL, 33779-0511, US

(21) Appl. No.: 10/328,877

(22) Filed: Dec. 24, 2002

(51) Int. Cl. F24F 3/00; G05D 23/00; F25B 29/00; F28D 1/00

(52) U.S. Cl. 165/218; 165/287; 165/299; 165/48.1; 165/48.2; 165/45

(57) ABSTRACT

An environmental air treatment system has a living space, a rooftop combination air intake and exhaust housing with an internal hollow chamber, and a thermal exchange unit within the chamber forming intake and exhaust sides and openings. A plurality of ducts form a continuous duct work system and have a plurality of duct work registers. An air movement fan housing is coupled to the duct work and the registers. Within the fan housing are a plurality of components: a fan, fan motor, a plurality of heat exchange units, and a plurality of pipe connections coupling with the heat exchange units. A hot water source and a cold water source are coupled to the heat exchangers. A thermostat is electronically controlled. A plurality of water mixing valves are coupled in-line of the hot and cold water supply pipes.

### BACKGROUND OF THE INVENTION

1. Field of the Invention

The present invention relates to an environmental air treatment system and more particularly pertains to safely and conveniently allowing a user to efficiently manage the heating and cooling of a living space.

2. Description of the Prior Art

The use of other methods and systems of known configurations is known in the prior art. More specifically, other methods and systems of known configurations previously devised and utilized for the purpose of heating and cooling the air within a living space are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 5,183,102 issued to Clark on Feb. 2, 1993, discloses a heating and cooling system which utilizes hot and cold water services to a building to supply heating and cooling to a living space. U.S. Pat. No. 4,375,831 issued to Downing, Jr., issued on Mar. 8, 1983 discloses discloses a geothermal heating and cooling system. U.S. Pat. No. 6,422,319 issued to Haase III on Jul. 23, 2002 discloses a water distribution network for domestic and fire prevention. U.S. Pat. No. 5,975,192 issued to Maratalla, et al on Nov. 2, 1999 discloses an attic air conditioning unit.

While these devices fulfill their respective, particular objectives and requirements, the aforementioned patents do not describe environmental air treatment system that allows one to safely and conveniently manage the heating and cooling of a living space.

In this respect, the environmental air treatment system according to the present invention substantially departs from the conventional concepts and designs of the prior art, and in doing so provides an apparatus primarily developed for the purpose of safely and conveniently allowing a user to efficiently manage the heating and cooling of a living space.

Therefore, it can be appreciated that there exists a continuing need for a new and improved environmental air treatment system which can be used to safely and conveniently allow a user to efficiently manage the heating and cooling of a living space. In this regard, the present invention substantially fulfills this need.

### SUMMARY OF THE INVENTION

In view of the foregoing disadvantages inherent in the known types of other methods and systems of known configurations now present in the prior art, the present invention provides an improved environmental air treatment system. As such, the general purpose of the present invention, which will be described subsequently in greater detail, is to provide a new and improved environmental air treatment system and method which has all the advantages of the prior art and none of the disadvantages.

To attain this, the present invention essentially comprises an environmental air treatment system to safely and conveniently allow a user to efficiently manage the heating and cooling of a living space. The system comprises, in combination the following components. First provided is a living space. The living space comprises walls, a ceiling and a floor. There is an enclosed space within said walls, ceiling and floor. The living space has a sleeping area and a toilet area and a bathroom area. Next provided is a rooftop combination air intake and air exhaust housing. The housing has four parallel opposing sides and a lower bottom floor and an upper top. The sides, top and lower floor form an internal hollow chamber. The chamber has a thermal exchange unit housed within the interior of the chamber thereby forming an intake side and an exhaust side. The housing also has an exhaust opening and an intake opening. The thermal exchange unit allows for the utilization of warmed exhaust air used during a heating application to warm the cooler incoming air and the utilization of cool outflowing air used during a cooling application to cool the warmer incoming air. Next provided is a plurality of ducts forming a duct work system. The ducts are coupled with the housing and thereby forming a continuous internal hollow pathway within the duct work. Next provided is a plurality of duct work registers being located within the walls and ceiling of the living space. The duct work is coupled to the registers, with the registers having an opening and closing mechanism to restrict the passage of air through the register into and out of the duct work. Next provided is an air movement fan housing, also known as an air handler flow housing. The fan housing has a hollow rectangular configuration and is fabricated of rigid material. The housing has an intake aperture and an outflow aperture. The intake aperture is coupled to the duct work which is in turn coupled to the intake aperture and to the intake opening of the rooftop air intake housing. The outflow aperture is coupled by the duct work to a plurality of registers located within the living space. The flow housing has contained therein a plurality of components. The components comprise a fan and a fan motor and two heat exchange units, a hot water unit and a cold water unit. Also included is a plurality of pipe connections coupling with the heat exchange units. The housing also has an internal drip containment pan with a drain plug to capture and contain condensation and to allow the convenient draining of the pan. Next provided is a hot water source from the class of hot water sources containing an electrically heated water source, and a gas heated water source and a solar heated water source. Hot water piping is coupled to the hot water source and to the hot water heat exchanger to serve as an enclosed conduit to allow the passage of heated water into the heat exchanger located within the flow housing. Next provided is a cold water source from the class of water sources containing an electrically cooled water source, and a gas cooled water source and a geothermically cooled water source. Cold water piping is coupled to the cold water source and to the cold water heat exchanger to serve as an enclosed conduit to allow the passage of cold water into the heat exchanger inside of the flow housing. The hot and cold sources thereby allow the heat exchanger to provide a source of heat or cold within the housing. Next provided is an electronically controlled thermostat. The thermostat is located within the confines of the living space and positioned to allow the convenient and accurate monitoring of air temperature within the living space. Lastly provided is a plurality of water mixing valves being coupled in-line of the hot and cold water supply pipes. The mixing valves are coupled electronically to the thermostat. The mixing valves allow for the control of the amount of heated or cooled water that is directed to the heat exchanger within the air handler flow housing.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved environmental air treatment system which has all of the advantages of the prior art of other methods and systems of known configurations and none of the disadvantages.

It is another object of the present invention to provide a new and improved environmental air treatment system which may be easily and efficiently manufactured and marketed.

It is further object of the present invention to provide a new and improved environmental air treatment system which is of durable and reliable constructions.

An even further object of the present invention is to provide a new and improved environmental air treatment system which is susceptible of a low cost of manufacture with regard to both materials and labor, and which accordingly is then susceptible of low prices of sale to the consuming public, thereby making such environmental air treatment system economically available to the buying public.

Even still another object of the present invention is to provide a environmental air treatment system to safely and conveniently allow a user to efficiently manage the heating and cooling of a living space.

Lastly, it is an object of the present invention to provide a new and improved environmental air treatment system. A living space comprises walls, ceiling and floor enclosing a space. A rooftop combination air intake and air exhaust housing has an internal hollow chamber with a thermal exchange unit housed within the interior of the chamber forming an intake side and an exhaust side. There is an exhaust opening and an intake opening into the chamber. A plurality of ducts form a continuous duct work system. There is a plurality of duct work registers. An air movement fan housing is coupled to the duct work and the registers. The fan housing has contained therein a plurality of components comprising a fan and fan motor and a plurality of heat exchange units and a plurality of pipe connections coupling with the heat exchange units. A hot water source and a cold water source are coupled to each of the heat exchangers. A thermostat is electronically controlled. A plurality of water mixing valves are coupled in-line of the hot and cold water supply pipes. A plurality of 3-way valves are coupled electronically to the thermostat. The valves are located in-line in the hot and cold water piping to allow the bypassing of the heat exchanger within the air handler while continuing to supply hot and cold water ot the living space. A plurality of 2-way actuator valves are located in-line of the water piping to the heat exchanger. The 2-way actuator valves are coupled to the thermostat and thereby allow the supply of hot and cold water to the heat exchanger, and the cessation of hot and cold water flow to the heat exchanger within the air handler. The water supply is controlled by the thermostat and each valve is electronically coupled to the thermostat. A plurality of 3-way valves allow the bypassing of the heat exchanger by the hot and cold water. The valves are controlled by the thermostat and are electronically coupled to the thermostat. A plurality of 2-way actuator valves allow the termination of water supply to the heat exchanger. The 2-way valves are also electronically coupled to, and controlled by, the thermostat. A plurality of fire sprinkler outlets are coupled to the cold water source piping in the living space. The use of the fire sprinklers as a component of the cooling system provides for the continuous circulation of the fire sprinkler water within the pipes, preventing corrosion and blockage.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a cut away side elevation of a structure constructed in accordance with the principles of the present invention.

FIG. 2 is a perspective view of the water supply adjacent to the valves.

FIG. 3 is a perspective view of the water take away adjacent to the valves, the take away being the piping away from the heat exchanger.

FIG. 4 is a perspective side view demonstrating a plurality of levels of living space and the water supplies to those living spaces.

FIG. 5 is a perspective view of the hot water supply and cold water supply as well as riser return pipes.

FIG. 6 is a perspective view of the hot water supply and riser piping.

FIG. 7 is a perspective view of the sanitary riser system of the living space.

FIG. 8 is an planar overview of the cold water supply to the heat exchanger.

FIG. 9 is a planar overview of the hot water supply to the heat exchanger.

FIG. 10 is a planar overview of the piping of the system of the present invention.

FIG. 11 is a schematic of the utilization of the system to provide heat to a swimming pool and spa.

FIG. 12 is a planar side view of an air movement fan housing, demonstrating the piping and the exchanger.

FIG. 13 is a planar overview of a heat exchanger of the present system.

FIG. 14 is a planar overview of a second heat exchanger of the present system.

FIG. 15 is a perspective of a water heater utilized to provide hot water to the system.

FIG. 16 is a perspective internal view of an air movement fan housing and the fresh air supply duct work.

FIG. 17 is a cut away perspective of a exhaust air pathway from living space to duct work.

FIG. 18 is a perspective of the system in place within the living space.

The same reference numerals refer to the same parts throughout the various Figures.

### DESCRIPTION OF THE PREFERRED EMBODIMENT

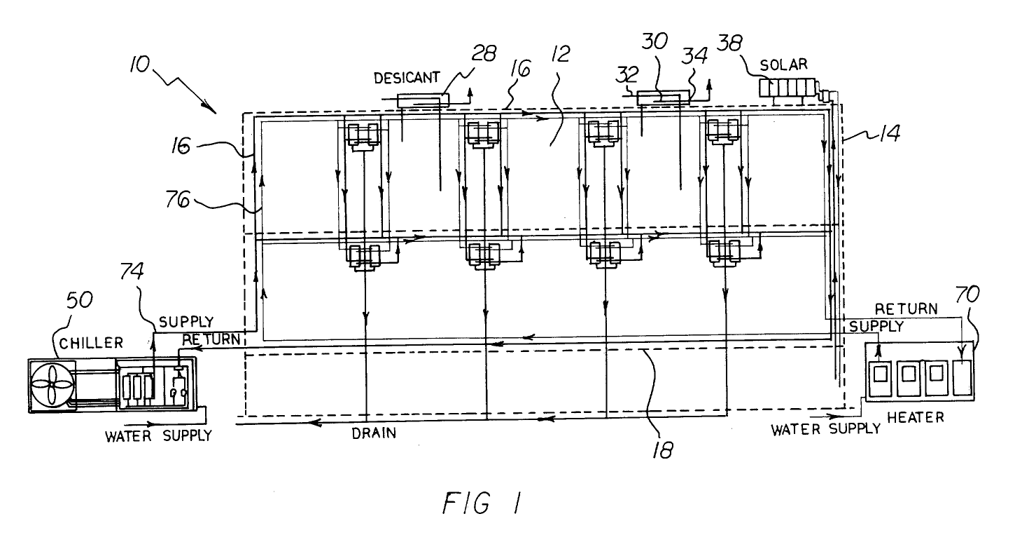

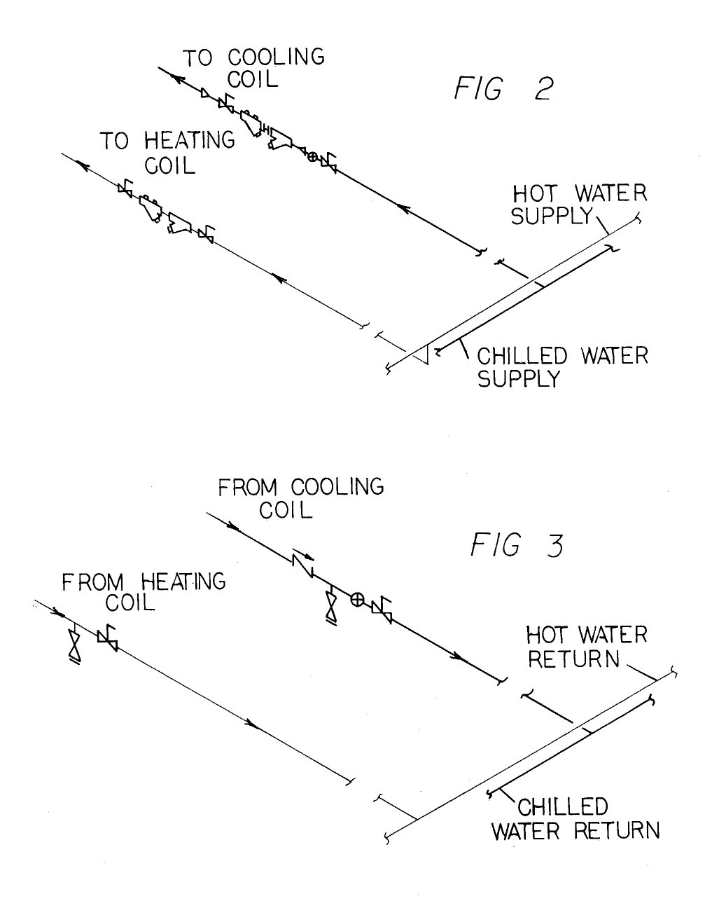

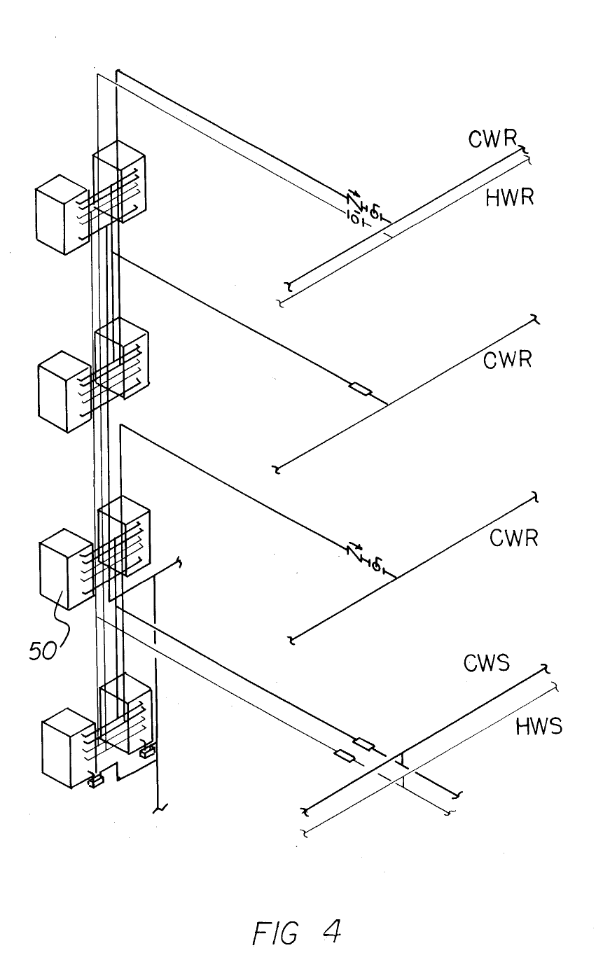

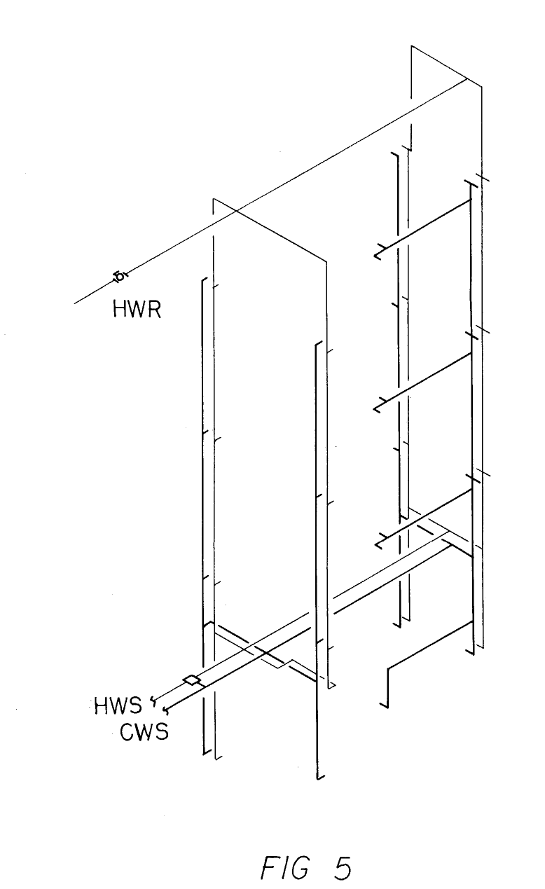

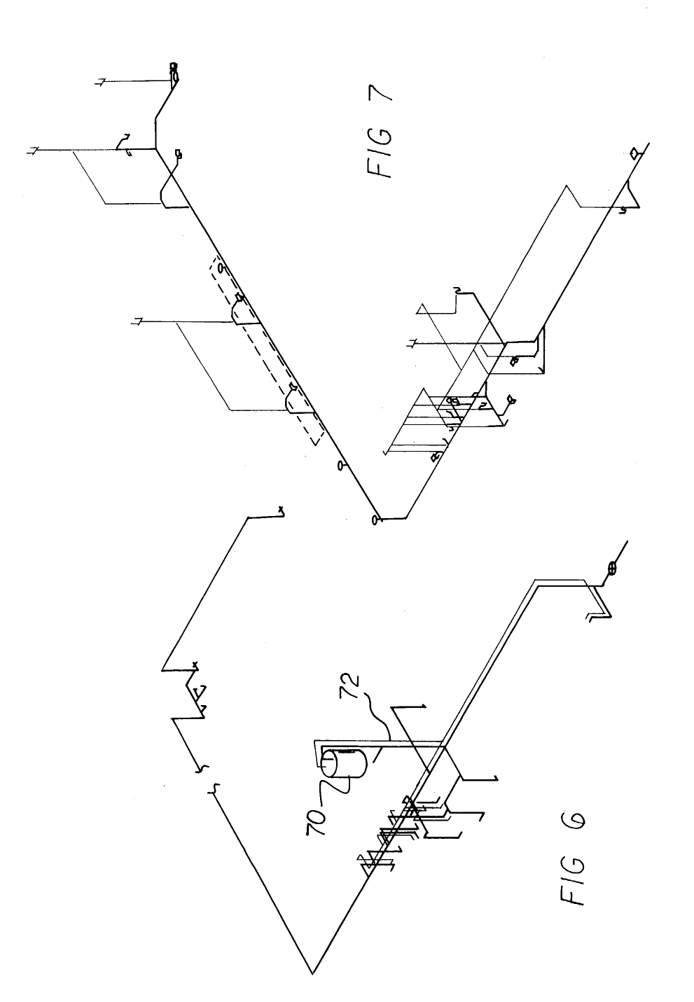

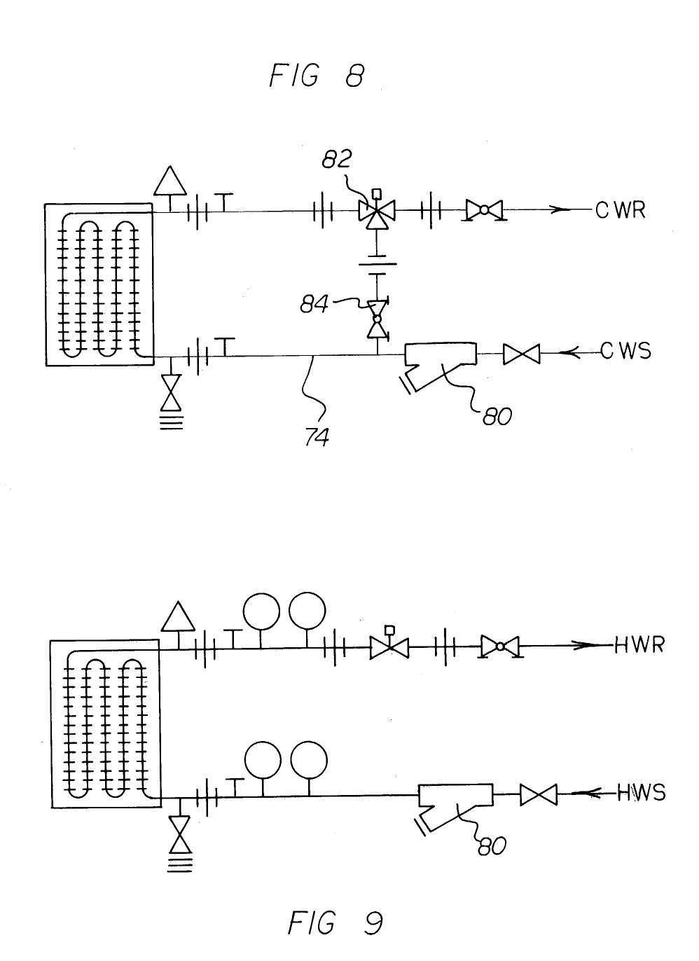

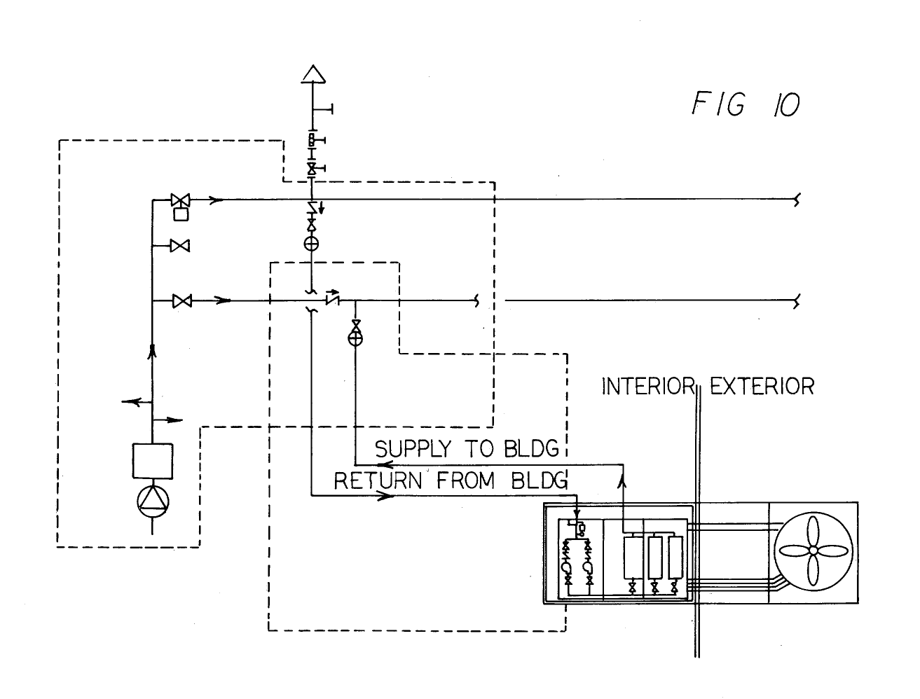

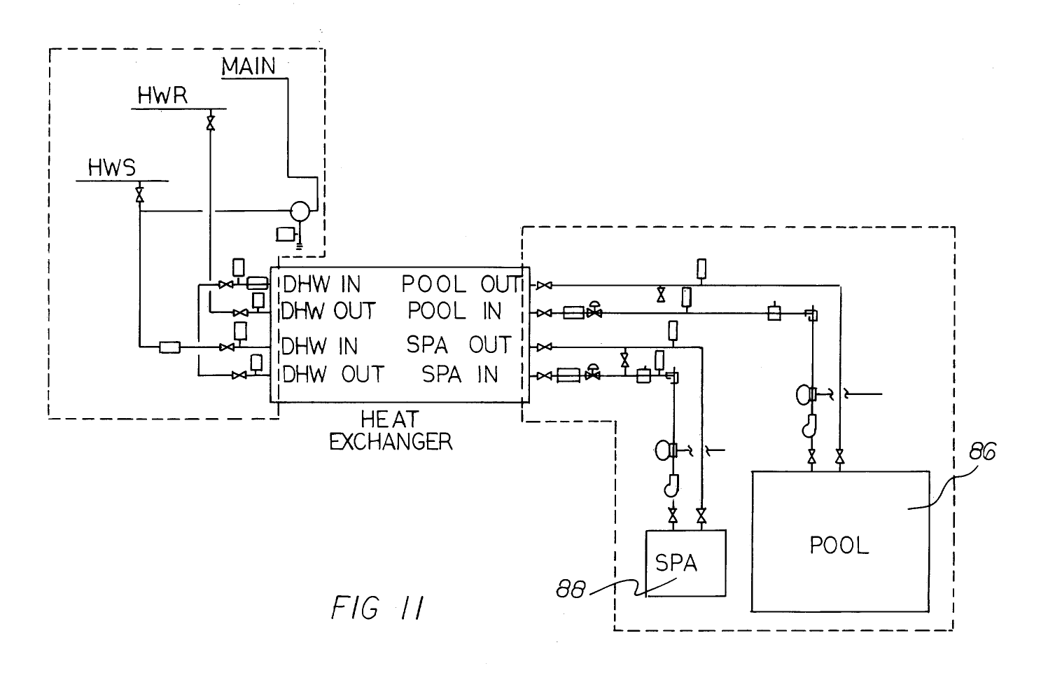

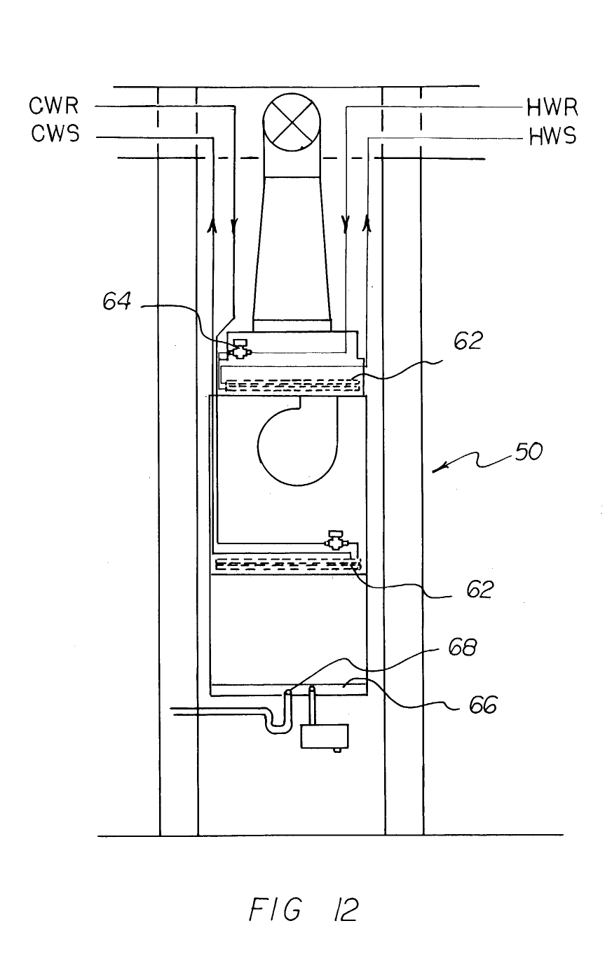

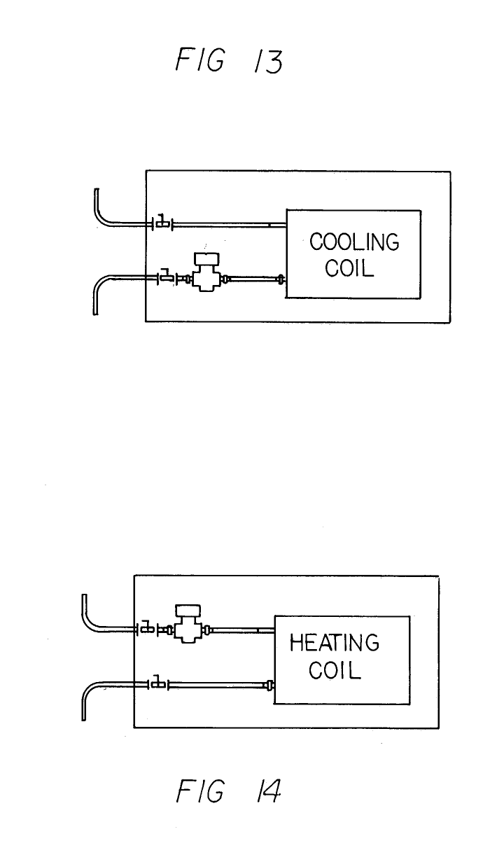

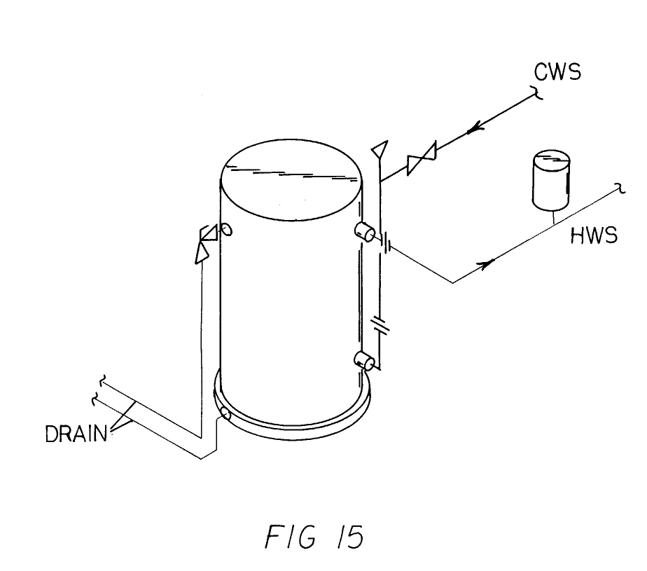

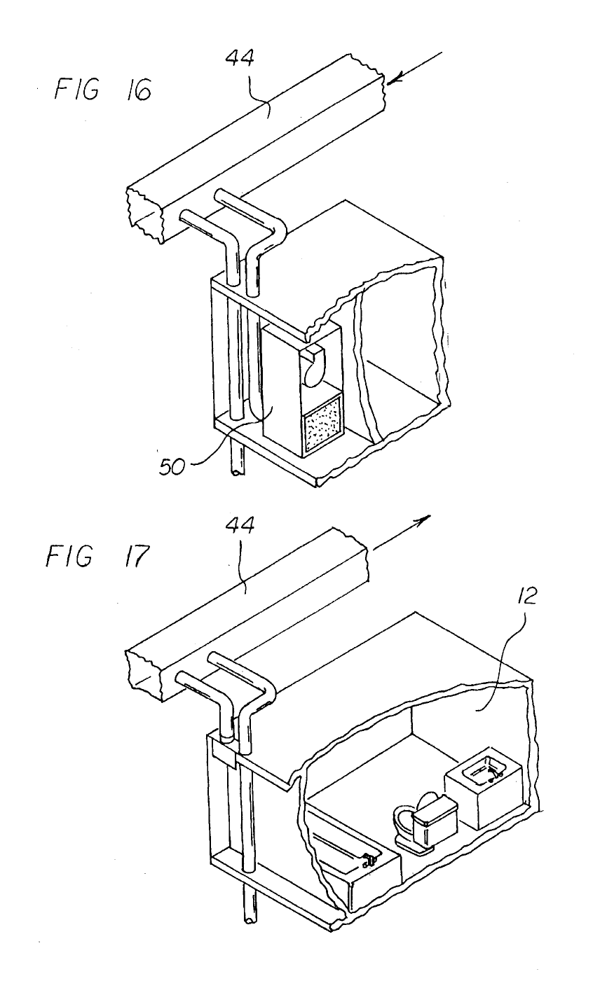

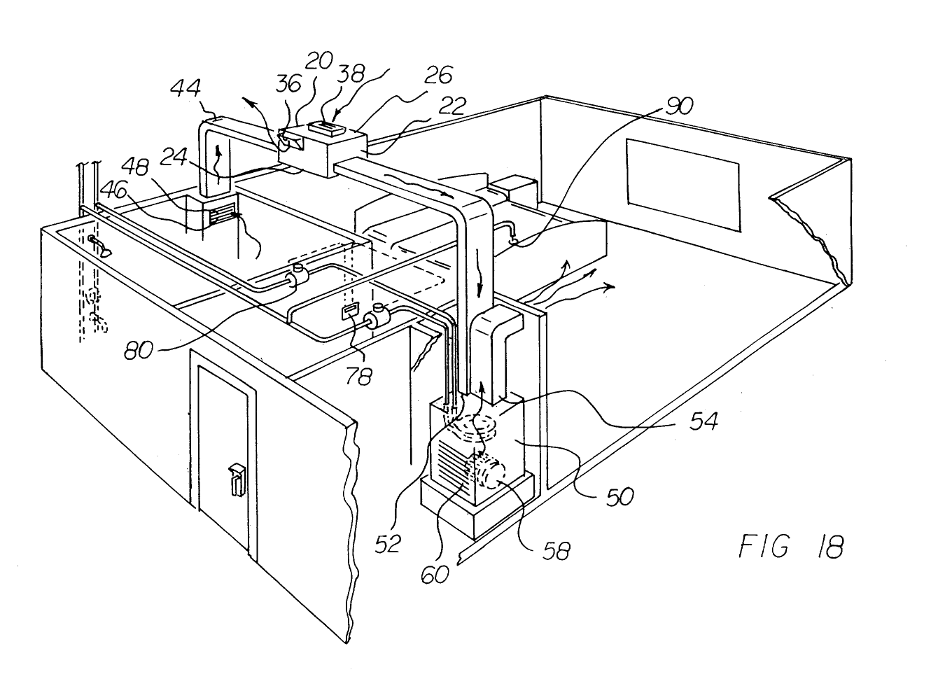

With reference now to the drawings, and in particular to FIG. 1 thereof, the preferred embodiment of the new and improved environmental air treatment system embodying the principles and concepts of the present invention and generally designated by the reference numeral 10 will be described.

The present invention, the environmental air treatment system 10 is comprised of a plurality of components. Such components in their broadest context include a thermal exchanger, a plurality of heat exchangers, a plurality of ducts forming duct work and an air handler. Such components are individually configured and correlated with respect to each other so as to attain the desired objective.

An environmental air treatment system 10 to safely and conveniently allow a user to efficiently manage the heating and cooling of a living space. The system comprises, in combination the following components. First provided is a living space 12. The living space comprises walls 14, a ceiling 16 and a floor 18. There is an enclosed space within said walls, ceiling and floor. The living space has a sleeping area and a toilet area and a bathroom area.

Next provided is a rooftop combination air intake and air exhaust housing 20. The housing has four parallel opposing sides 22 and a lower bottom floor 24 and an upper top 26. The sides, top and lower floor form an internal hollow chamber 28. The chamber has a thermal exchange unit 30 housed within the interior of the chamber thereby forming an intake side 32 and an exhaust side 34. The housing also has an exhaust opening 36 and an intake opening 38. The thermal exchange unit allows for the utilization of warmed exhaust air used during a heating application to warm the cooler incoming air and the utilization of cool outflowing air used during a cooling application to cool the warmer incoming air.

Next provided is a plurality of ducts 44 forming a duct work system. The ducts are coupled with the housing and thereby forming a continuous internal hollow pathway within the duct work.

Next provided is a plurality of duct work registers 46 being located within the walls and ceiling of the living space. The duct work is coupled to the registers, with the registers having an opening and closing mechanism 48 to restrict the passage of air through the register into and out of the duct work.

Next provided is an air movement fan housing 50, also known as an air handler flow housing. The fan housing has a hollow rectangular configuration and is fabricated of rigid material. The housing has an intake aperture 52 and an outflow aperture 54. The intake aperture is coupled to the duct work which is in turn coupled to the intake aperture and to the intake opening of the rooftop air intake housing. The outflow aperture is coupled by the duct work to a plurality of registers located within the living space.

The flow housing has contained therein a plurality of components. The components comprise a fan 58 and a fan motor 60 and a plurality of heat exchange units 62 and a plurality of pipe connections 64 coupling with the heat exchange unit. The housing also has an internal drip containment pan 66 with a drain plug 68 to capture and contain condensation and to allow the convenient draining of the pan.

Next provided is a hot water source 70 from the class of hot water sources containing an electrically heated water source, and a gas heated water source and a solar heated water source. Hot water piping 72 is coupled to the hot water source and to the heat exchanger to serve as an enclosed conduit to allow the passage of heated water into the heat exchanger located within the flow housing.

Next provided is a cold water source 74 from the class of water sources containing an electrically cooled water source, and a gas cooled water source and a geothermically cooled water source. Cold water piping 76 is coupled to the cold water source and to the heat exchanger to serve as an enclosed conduit to allow the passage of cold water into the heat exchanger inside of the flow housing. The hot and cold sources thereby allow the heat exchanger to provide a source of heat or cold within the housing.

Next provided is an electronically controlled thermostat 78. The thermostat is located within the confines of the living space and positioned to allow the convenient and accurate monitoring of air temperature within the living space.

Next provided is a plurality of water mixing valves 80 being coupled in-line of the hot and cold water supply pipes. The mixing valves are coupled electronically to the thermostat. The mixing valves allow for the control of the amount of heated or cooled water that is directed to the heat exchanger within the air handler flow housing.

Next provided is a plurality of 3-way valves 82 which allow the bypassing of the heat exchanger by the hot and cold water. The valves are controlled by the thermostat and are electronically coupled to the thermostat.

Next provided is a plurality of 2-way actuator valves 84 that allow the termination of water supply to the heat exchanger. The 2-way valves are also electronically coupled to and controlled by, the thermostat.

In an alternate configuration, the system may also provide a source for heating the water of a swimming pool 86 or a spa 88.

Lastly provided is a plurality of fire sprinkler outlets 90 being coupled to the cold water source piping in the living space. The use of the fire sprinklers as a component of the cooling system provides for the continuous circulation of the fire sprinkler water within the pipes, preventing corrosion and blockage.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. An environmental air treatment system to safely and conveniently allow a user to efficiently manage the heating and cooling of a living space comprising, in combination;
a living space comprising walls, ceiling and floor and having an enclosed space within the walls and ceiling, with the living space having a sleeping area and a toilet area and a bathroom area;
a rooftop combination air intake and air exhaust housing having four parallel opposing sides and a lower bottom floor and an upper top, with the sides, top and lower floor forming an internal hollow chamber, with the chamber having a thermal exchange unit housed within the interior of the chamber forming an intake side and an exhaust side, with the housing also having an exhaust opening and an intake opening, with the thermal exchange unit allowing for the utilization of warmed exhaust air used during a heating application to warm the cooler incoming air and the utilization of cool outflowing air used during a cooling application to cool the warmer incoming air;
a plurality of ducts forming a duct work system, with the ducts coupled with the housing and thereby forming a continuous internal hollow pathway within the duct work;
a plurality of duct work registers being located within the walls and ceiling of the living space with the duct work being coupled to the registers and with the registers having an opening and closing mechanism to restrict the passage of air through the register into and out of the duct work;
an air movement fan housing, also known as an air handler flow housing, having a hollow rectangular configuration and fabricated of rigid material with the housing having an intake aperture and an outflow aperture, with the intake aperture being coupled to the duct work which in turn couples the intake aperture to the intake opening of the rooftop air intake housing and the outflow aperture being coupled by the duct work to a plurality of registers located within the living space, the flow housing having contained therein a plurality of components comprising a fan and fan motor and a hot water heat exchange unit and a cold water heat exchange unit and a plurality of pipe connections coupling with the heat exchange unit, with the housing also having an internal drip containment pan with a drain plug to capture and contain condensation and to allow the convenient draining of the pan;
a hot water source from the class of hot water sources comprising an electrically heated water source and a gas heated water source and a solar heated water source and with hot water piping coupled to the hot water source and to a heat exchanger to serve as an enclosed conduit to allow the passage of heated water into the heat exchanger located within the flow housing;
a cold water source from the class of water sources comprising an electrically cooled water source and a gas cooled water source and a geothermically cooled water source and with cold water piping coupled to the cold water source and to a heat exchanger to serve as an enclosed conduit to allow the passage of cold water into the heat exchanger inside of the flow housing, thereby allowing the heat exchanger to provide a source of heat or cold within the housing;
an electronically controlled thermostat being located within the confines of the living space and positioned to allow the convenient and accurate monitoring of air temperature within the living space;
a plurality of water mixing valves being coupled in-line of the hot and cold water supply pipes, with the mixing valves being coupled electronically to the thermostat, the mixing valves allowing for the control of the amount of heated or cooled water that would be conducted to the heat exchanger within the air handler flow housing;
a plurality of 3-way valves coupled electronically to the thermostat, the valves being located in-line in the hot and cold water piping to allow the bypassing of the heat exchanger within the air handler while continuing to supply hot and cold water to the living space;
a plurality of 2-way actuator valves located in-line of the water piping to the heat exchanger, with the 2-way actuator valve being coupled to the thermostat thereby allowing the supply of hot and cold water to the heat exchanger and the cessation of hot and cold water flow to the heat exchanger within the air handler, the water supply being controlled by the thermostat and each valve being electronically coupled to the thermostat; and
a plurality of fire sprinkler outlets with each being coupled to the cold water source piping in the living space.

2. An environmental air treatment system comprising, in combination;
a living space comprising walls, ceiling and floor and having an enclosed space within said walls and ceiling;
a rooftop combination air intake and air exhaust housing having an internal hollow chamber, with a thermal exchange unit housed within the interior of the chamber forming an intake side and an exhaust side, with an exhaust opening and an intake opening;
a plurality of ducts forming a continuous duct work system;
a plurality of duct work registers;
an air movement fan housing coupled to the duct work and the registers and having contained therein a plurality of components comprising a fan and fan motor and a plurality of heat exchange units and a plurality of pipe connections coupling with the heat exchange unit;
a hot water source coupled to the heat exchanger;
a cold water source coupled to the heat exchanger;
an electronically controlled thermostat; and
a plurality of water mixing valves being coupled in-line of the hot and cold water supply pipes.

3. An environmental air treatment system as described in claim 2 wherein the system further comprises a plurality of hot and cold water risers which allow the system to be used in a multiple level structure.

4. An environmental air treatment system as described in claim 2 wherein the system further comprises an air treatment system for a swimming pool and spa area, with the system also providing a means to warm the pool and spa water.

5. An environmental air treatment system as described in claim 2 wherein the system further comprises a plurality of 3-way valves being coupled electronically to the thermostat, the valves being located in-line in the hot and cold water piping to allow the bypassing of the heat exchanger within the air handler while continuing to supply hot and cold water to the living space.

6. An environmental air treatment system as described in claim 2 wherein the system further comprises a plurality 2-way actuator valves being located in-line of the water piping to the heat exchanger, with the two-way actuator valve being coupled to the thermostat and thereby allowing the supply of hot and cold water to the heat exchanger and the cessation of hot and cold water flow to the heat exchanger within the air handler, the water supply being controlled by the thermostat and each valve being electronically coupled to the thermostat.

7. An environmental air treatment system as described in claim 2 wherein the system further comprises a plurality of fire sprinkler outlets being coupled to the cold water supply of the living space.
